(19) United States
(12) Patent Application Publication
(10) Pub. No.: US 2006/0227976 A1
(43) Pub. Date: Oct. 12, 2006

(54) Binaural hearing instrument systems and methods

(75) Inventors: Brian D. Csermak, Dundas (CA); Philippe Pango, Stoney Creek (CA); James G. Ryan, Ottawa (CA); Ken Smith, Burlington (CA)

Correspondence Address: STEPHEN D. SCANLON, JONES DAY, 901 LAKESIDE AVENUE, CLEVELAND, OH, 44114, US

(73) Assignee: Gennum Corporation

(21) Appl. No.: 11/100,732

(22) Filed: Apr. 7, 2005

(51) Int. Cl. H04R 5/00

(52) U.S. Cl. 381/1

(57) ABSTRACT

Binaural hearing instrument systems and methods are provided. The binaural hearing instrument system may include communications circuitry that is used to transmit data between left and right hearing instruments. The left and right hearing instruments may include binaural processing circuits that generate left and right audio output signals, respectively, as a function of the signal-to-noise ratios (SNRs) of both the left and right audio input signals. The data transmitted between the left and right hearing instruments by the communications circuitry may be used to provide the SNR of the left audio input signal to the right hearing instrument and to provide the SNR of the right audio input signal to the left hearing instrument. In one example, the data transmitted between the left and right hearing instruments may include audio signals that may be used to determine the SNRs of the left and right audio input signals.

### FIELD

The technology described in this patent document relates generally to the field of hearing instruments. More particularly, systems and methods are provided for implementing a binaural hearing instrument.

### BACKGROUND AND SUMMARY

Typical hearing instruments that include wireless communications circuitry may include many disadvantages that are overcome by the binaural hearing instrument systems and methods described herein.

In accordance with the teachings described herein, a binaural hearing instrument systems and methods are provided. The binaural hearing instrument system may include communications circuitry that is used to transmit data between left and right hearing instruments. The left and right hearing instruments may include binaural processing circuits that generate left and right audio output signals, respectively, as a function of the signal-to-noise ratios (SNRs) of both the left and right audio input signals. The data transmitted between the left and right hearing instruments by the communications circuitry may be used to provide the SNR of the left audio input signal to the right hearing instrument and to provide the SNR of the right audio input signal to the left hearing instrument. In one example, the data transmitted between the left and right hearing instruments may include audio signals that may be used to determine the SNRs of the left and right audio input signals.

### BRIEF DESCRIPTION OF THE DRAWINGS

FIG. 1 is a block diagram that depicts an example binaural hearing instrument system in which data is communicated wirelessly between a left and a right hearing instrument.

FIG. 2 depicts an example binaural hearing instrument system in which signal-to-noise ratio (SNR) data is communicated between hearing instruments.

FIG. 3 depicts an example binaural hearing instrument system in which audio data is communicated between hearing instruments.

FIG. 4 is a block diagram of an example hearing instrument that may be used in a binaural hearing instrument system.

FIG. 5 is a functional diagram of a binaural hearing instrument system.

FIG. 6 is a block diagram depicting an example binaural hearing instrument.

FIG. 7 is a block diagram depicting another example binaural hearing instrument.

FIG. 8 is a block diagram of an example hearing instrument showing a more-detailed example of communications circuitry.

FIG. 9 is a functional diagram of an example baseband processor for a hearing instrument.

### DETAILED DESCRIPTION

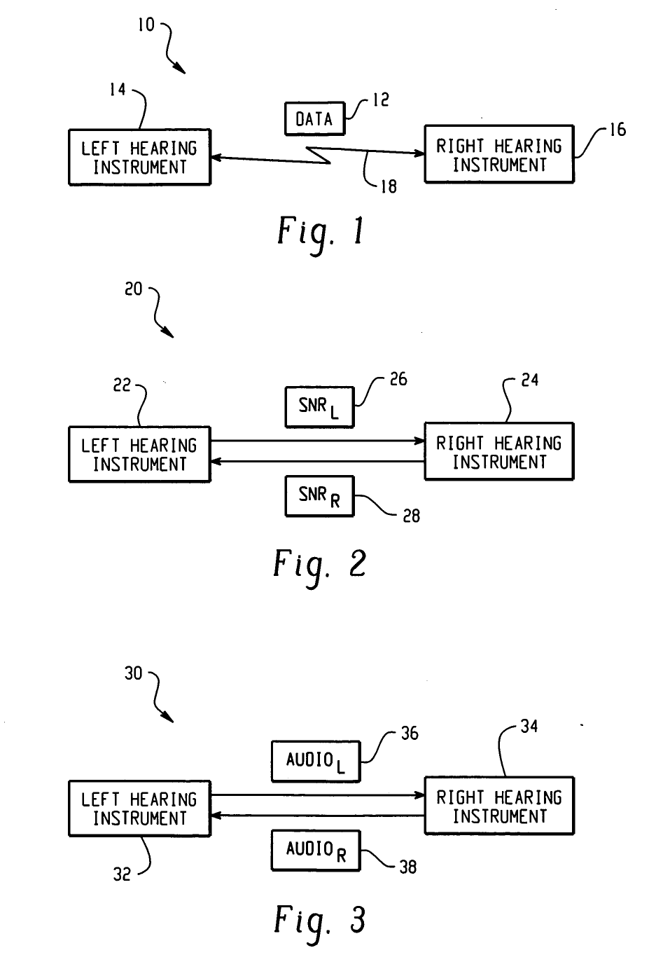

FIG. 1 is a block diagram that depicts an example binaural hearing instrument system 10 in which data 12 is communicated between a left hearing instrument 14 and a right hearing instrument 16 over a wireless link 18. In addition to traditional hearing instrument functions, these hearing instruments 14, 16 include communications circuitry for sending and receiving information over an air medium. The data 12 transmitted between the hearing instruments 14, 16 may include, for example, control data, signal measurements (e.g., signal-to-noise ratios), audio signals, and/or other data. The amount and type of data 12 transmitted between the hearing instruments 14, 16 may depend on the bandwidth of the wireless link 18. For example, a low bandwidth wireless connection may not support the transmission of audio data.

In operation, the data 12 transmitted between the left and right hearing instrument 14, 16 may be used to dynamically adjust the audio output of a hearing instrument based on information received from the other hearing instrument. For example, hearing-impaired individuals wearing two hearing instruments may often find it preferable to lower the volume of one hearing instrument in certain environments (such as a noisy restaurant) and increase the volume of the hearing instrument facing the signal of interest. The example binaural hearing instrument system 10 of FIG. 1 may automatically perform a similar function by dynamically adjusting the gains of the hearing instruments based on data that is transmitted over the wireless link 18. In addition, if audio signals are transmitted between the hearing instruments, then audio from one hearing instrument may be mixed with audio from the other hearing instrument. For instance, an audio signal with the best signal-to-noise ratio (e.g., from the hearing instrument facing the signal of interest) may be mixed into the audio output of both hearing instruments.

FIG. 2 depicts an example binaural hearing instrument system 20 in which signal-to-noise ratio (SNR) data 26, 28 is communicated between hearing instruments 22, 24. The SNR data 26, 28 indicates the signal-to-noise ratio (SNR_{L} and SNR_{R}) of the audio signals received by the respective hearing instruments 22, 24. The respective gains of the hearing instruments 22, 24 may be adjusted as a function of the SNR 26, 28 measured in each of the hearing instruments 22, 24. That is, the left hearing instrument 22 may generate a left audio output signal as a function of both SNR_{L} and SNR_{R}, and the right hearing instrument 24 may generate a right audio output signal as a function of both SNR_{L} and SNR_{R}. For example, if SNR_{L} is low compared to SNR_{R}, then the gain in the left hearing instrument 22 may be decreased (or turned completely off). In the same example, the gain in the right hearing instrument 24 (with the higher SNR) may remain unchanged or may be increased. In this manner, the audio signal with the higher SNR may be made more prominent to the hearing instrument user in noisy environments.

FIG. 3 depicts an example binaural hearing instrument system 30 in which audio data (AUDIO_{L} and AUDIO_{R}) 36, 38 is communicated between hearing instruments 32, 34. The audio received by each hearing instrument 32, 34 may, for example, be digitized and streamed over the communication link to the other hearing instrument. In one example, the audio signals 36, 38 may be mixed as a function of their SNRs, and the combined audio signals may be used to generate the audio outputs of the hearing instruments. For instance, if the SNR of AUDIO_{L} is low compared to the SNR of AUDIO_{R}, then one or both of the audio outputs from the hearing instruments may be generated by mixing AUDIO_{L} and AUDIO_{R}, with AUDIO_{R} being the more prominent signal. In another example, the audio signal (AUDIO_{L} or AUDIO_{R}) with the higher SNR may be provided as the output from both hearing instruments 32, 34 (e.g., the gain of the audio signal with the lower SNR may be reduced to zero). In this manner, the audio signal with the higher SNR may be provided to the hearing instrument user in both ears.

In one example, the binaural hearing instrument system may be configured to switch between a plurality of operational modes, for example the operations illustrated in FIGS. 2 and 3. For instance, in one mode of operation the binaural hearing instrument system may transmit full audio between hearing instruments (e.g., FIG. 3), while in another mode of operation the binaural hearing instrument system may transmit SNR data and not full audio (e.g., FIG. 2). The hearing instrument system may, for example, switch between modes of operation in order to conserve power. For example, a user input may be communicated between the binaural hearing instruments (e.g., in the form of a control signal) to cause the hearing instruments to switch operational modes.

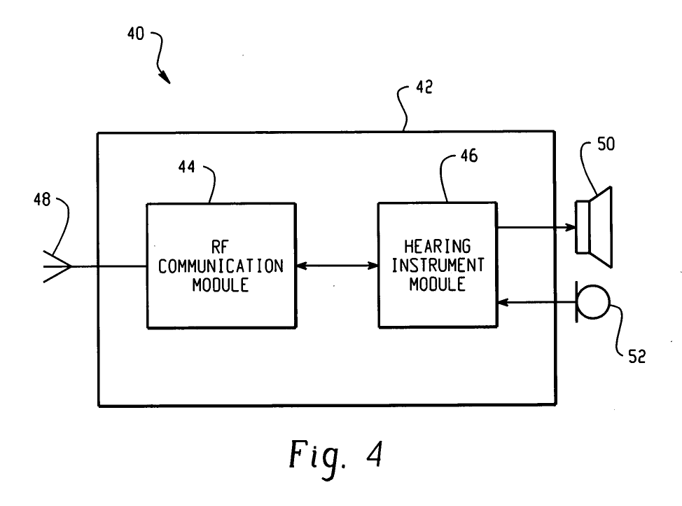

FIG. 4 is a block diagram of an example hearing instrument 40 that may be used in a binaural hearing instrument system. The hearing instrument 40 includes a hearing instrument circuit 42, an antenna 48, a receiver (i.e., a speaker) 50, and one or more microphones 52. The hearing instrument circuit 42 includes a RF communication module 44 and a hearing instrument module 46, which may be arranged on one or more printed circuit boards, thin film circuits, thick film circuits, or some other type of circuit that may be sized to fit within a hearing instrument shell. In one additional example, the RF communication module 44 may be included in an external attachment to the hearing instrument 40. The antenna 48 may be a low-power miniature antenna, such as the antenna described in the commonly-owned U.S. patent application Ser. No. 10/986,394, entitled “Antenna For A Wireless Hearing Aid System,” which is incorporated herein by reference.

The communications module 44 may include both transmitter and receiver circuitry for bi-directional communication, for example with another hearing instrument. The hearing instrument module 46 may perform traditional hearing instrument processing functions to compensate for the hearing impairments of a hearing instrument user, along with the binaural processing functions described herein. The hearing instrument module 46 may also perform other signal processing functions, such as directional processing, occlusion cancellation, or others. An example of hearing instrument processing and other signal processing functions that may be performed by the hearing instrument module, in addition to the binaural processing functions describe herein, is provided in commonly-owned U.S. patent application Ser. No. 10/121,221, entitled “Digital Hearing Aid System,” which is incorporated herein by reference.

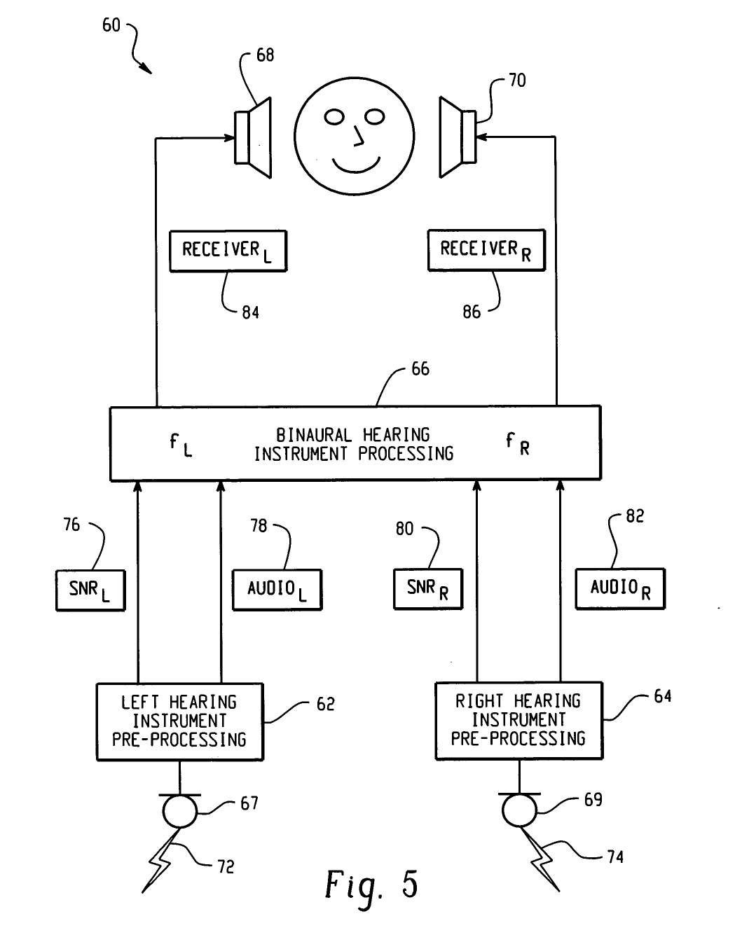

FIG. 5 is a functional diagram of a binaural hearing instrument system 60. The system 60 includes left hearing instrument pre-processing 62, right hearing instrument pre-processing 64, binaural hearing instrument processing, right and left microphones 67, 69 and left and right receivers 68, 70. The left and right hearing instrument pre-processing functions 62, 64 may be performed by circuitry in left and right hearing instruments, respectively. The binaural hearing instrument processing 66 is enabled by a communication link between a left and right hearing instrument, for example as illustrated in FIG. 1. The binaural hearing instrument processing functions 66 may be performed by circuitry in both the right and left hearing instruments.

In operation, the audio input signals 72, 74 are received by the left and right hearing instrument microphones 67, 69, and the received audio is processed 62, 64 to generate left and right digital audio signals 78, 82 (AUDIO_{L} and AUDIO_{R}) and to determine the signal-to-noise ratios 76, 80 (SNR_{L} and SNR_{R}). Binaural hearing instrument processing functions (f_{L} and f_{R}) are then performed using the digital audio signals (AUDIO_{L} and AUDIO_{R}) and the signal-to-noise ratios (SNR_{L} and SNR_{R}) in order to generate left and right audio output signals (RECEIVER_{L} and RECIEVER_{R}), which are transmitted to a hearing instrument user by the receivers 68, 70.

The left and right hearing instrument pre-processing functions 62, 64 may include analog-to-digital conversion, filtering, directional processing, and/or other digital signal processing functions to generate the digital audio signals 78, 82 (AUDIO_{L} and AUDIO_{R}). In addition, the received audio signals are further processed 62, 64 to determine their signal-to-noise ratios (SNR_{L} and SNR_{R}). The signal-to-noise ratios (SNR_{L} and SNR_{R}) may be updated at every sample of the digital audio signals (AUDIO_{L} and AUDIO_{R}), or may be calculated at a lower rate (e.g., decimated) in order to conserve processing power.

The binaural hearing instrument processing functions (f_{L} and f_{R}) 66 generate the audio output signals (RECEIVER_{L} and RECIEVER_{R}) as a function of the signal-to-noise ratios (SNR_{L} and SNR_{R}). By communicating the signal-to-noise ratios (SNR_{L} and SNR_{R}) across the communication link between hearing instruments, the gain of the audio output signals (RECEIVER_{L} and RECIEVER_{R}) may be adjusted as a function of both SNR_{L} and SNR_{R}. This may be expressed mathematically as follow:
RECEIVER_{L}=f_{L}(SNR_{R}, SNR_{L}, AUDIO_{L}); and
RECIEVER_{R}=f_{R}(SNR_{R}, SNR_{L}, AUDIO_{R}).

If full audio is transmitted over the communication link between the left and right hearing instruments, then the audio output signals (RECEIVER_{L} and RECIEVER_{R}) may be generated by mixing the digital audio signals (AUDIO_{L} and AUDIO_{R}), using the signal-to-noise ratios (SNR_{L} and SNR_{R}) as parameters. In this case, the binaural hearing instrument processing functions (f_{L} and f_{R}) may be expressed mathematically as mixing functions:
RECEIVER_{L}=f_{L}(SNR_{R}, SNR_{L}, AUDIO_{L}, AUDIO_{R}); and
RECIEVER_{R}=f_{R}(SNR_{R}, SNR_{L}, AUDIO_{L}, AUDIO_{R}).

In the case of full audio transmission, the mixing functions (f_{L} and f_{R}) may be reduced to a 2×4 matrix, as follows:

$$[ \begin{matrix}{RECEIVER}_{R} \\ {RECEIVER}_{L}\end{matrix} ] = [ \begin{matrix}{a}_{11} & {a}_{12} \\ {a}_{21} & {a}_{22}\end{matrix} ] [ \begin{matrix}{AUDIO}_{R} \\ {AUDIO}_{L}\end{matrix} ] ;$$

where the coefficients a11, a12, a21 and a22 are calculated based on the signal-to-noise ratios, SNR_{R}, and SNR_{L}.

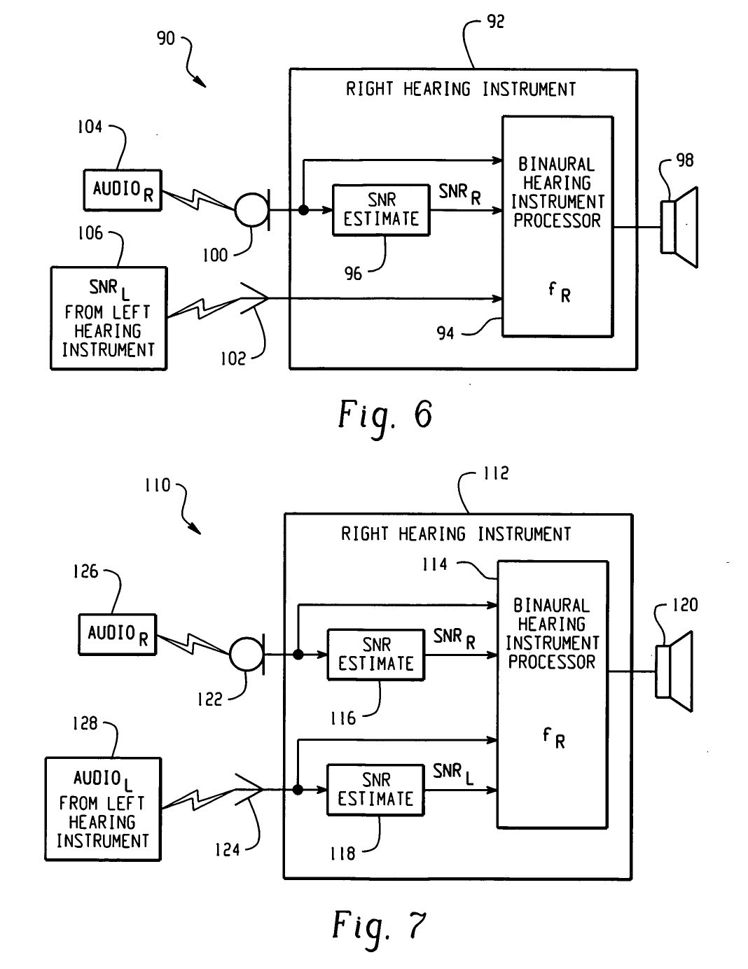

FIG. 6 is a block diagram depicting an example binaural hearing instrument 92. The illustrated example 92 shows a right hearing instrument 92, which may be included in a pair of right and left binaural hearing instruments in a binaural hearing instrument system. The example hearing instrument 92 includes a SNR estimation circuit 96, a binaural hearing instrument processor 94, a receiver 98, a microphone 100 and communications circuitry 102. The SNR estimation circuit 96 and binaural hearing instrument processor 94 may, for example, be implemented using one or more discrete circuit components, ASICs, processing devices (e.g., microprocessor, digital signal processor (DSP), etc.), or a combination thereof. The communications circuitry 102 may, for example, include one or more antennas and transmitter and receiver circuitry for bi-directional communication with another hearing instrument.

In operation, the hearing instrument 92 receives an audio input signal 104 via the microphone 100, and also receives data 106 from the left hearing instrument that identifies the signal-to-noise ratio (SNR_{L}) of the audio input to the left hearing instrument. The audio input signal 104 is input to the SNR estimation circuit 96, which determines its signal-to-noise ratio (SNR_{R}). The audio input signal 104 and SNR_{R} are input to the binaural hearing instrument processor 94, along with the SNR_{L} 106 from the left hearing instrument. The binaural hearing instrument processor 94 then adjusts a gain of the audio input signal 104 based on SNR_{R}, and SNR_{L} to generate an audio output signal to the receiver 98. In addition, the binaural hearing instrument processor 94 may process the audio input signal 104 to compensate for the hearing impairment of the hearing instrument user, and/or perform other signal processing function.

FIG. 7 is a block diagram depicting another example binaural hearing instrument 112. The example hearing instrument 112 includes two SNR estimation circuits 116, 118, a binaural hearing instrument processor 114, a receiver 120, a microphone 126 and communications circuitry 124. The SNR estimation circuits 116, 118 and binaural hearing instrument processor 114 may, for example, be implemented using one or more discrete circuit components, ASICs, processing devices (e.g., microprocessor, digital signal processor (DSP), etc.), or a combination thereof. The communications circuitry 124 may, for example, include one or more antennas and transmitter and receiver circuitry for bi-directional communication with another hearing instrument.

In this example 112, the illustrated hearing instrument receives an audio signal 128 from the other hearing instrument in a binaural hearing instrument system, and the SNR estimation circuits 116, 118 identify the signal-to-noise ratios (SNR_{L} and SNR_{R}) of the left and right audio signals 126, 128. The binaural hearing instrument processor 114 then generates the audio output to the receiver 120 as a function of both the signal-to-noise ratios (SNR_{L} and SNR_{R}) and the left and right audio signals 126, 128. For example, the audio signals 126, 128 may be mixed by the binaural hearing instrument processor 114 as a function of their SNRs (SNR_{L} and SNR_{R}), and the combined audio signals may be used to generate the audio output to the receiver 120.

It should be understood that FIGS. 6 and 7 illustrate circuitry in a right hearing instrument for the purposes of example. In a binaural hearing instrument system, similar circuitry may also be included in a left hearing instrument.

The illustrated examples in FIGS. 2 and 5-7 shows a single SNR value (SNR_{L} and SNR_{R}) being calculated and wirelessly transmitted from each hearing instrument. It should be understood, however, that in some examples more than one SNR value may be used. For example, a hearing instrument may process audio signals in multiple narrow bands (e.g., some hearing instruments have 128 bands), and SNRs for each of these bands may be calculated and transmitted over the wireless link.

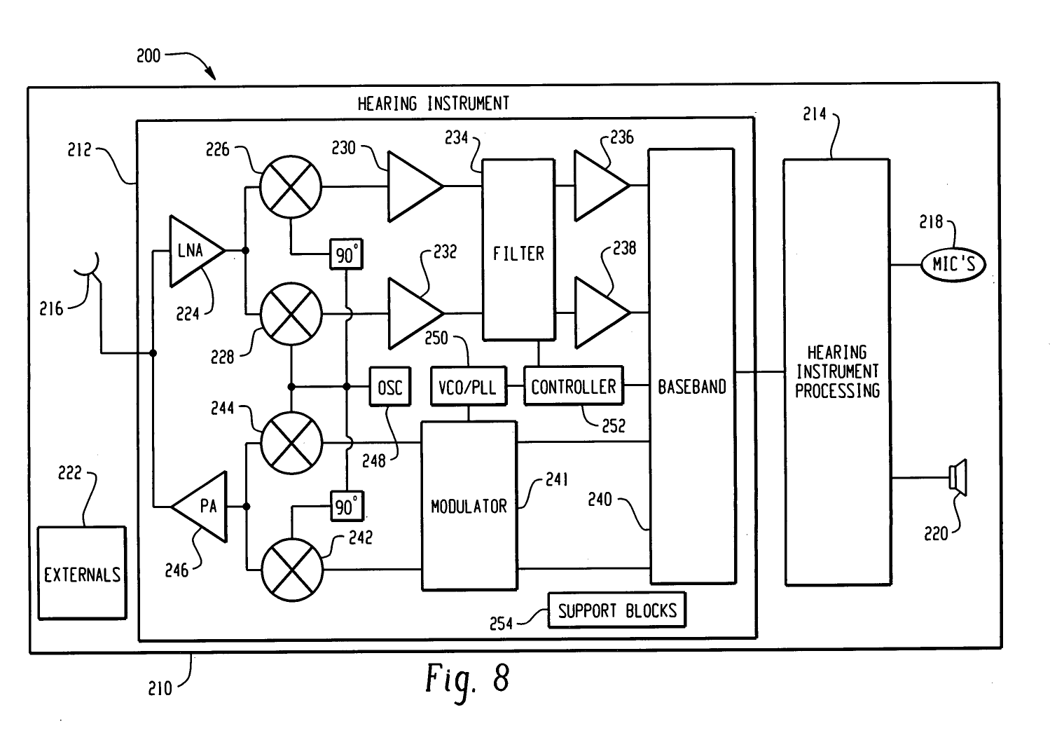

FIG. 8 is a block diagram of an example hearing instrument 200 showing a more-detailed example of communications circuitry. The example hearing instrument 200 includes an RF communication module 212, a hearing instrument processor 214, an antenna 216, one or more hearing instrument microphones 218, a hearing instrument speaker 220 and one or more external components 222 (e.g., resistive and reactive circuit components, filters, oscillators, etc.) As illustrated, the RF communication module 212 and the hearing instrument processor 214 may each be implemented on a single integrated circuit, but in other examples could include multiple integrated circuits and/or external circuit components.

The RF communication module 212 includes a baseband processor 240 and communications circuitry. The communications circuitry includes a transmit path and a receive path. The receive path includes a low noise amplifier (LNA) 224, a down conversion quadrature mixer 226, 228, buffering amplifiers 226, 228, an I-Q image reject filter 234 and a slicer 236, 238. The transmit path includes a modulator 241, an up conversion quadrature mixer 242, 244 and a power amplifier 246. The receive and transmit paths are supported and controlled by the baseband processor 240 and clock synthesis circuitry 248, 250, 252. The clock synthesis circuitry includes an oscillator 248, a phase locked loop circuit 250 and a controller 252. The oscillator 248 may, for example, use an off chip high Q resonator (e.g., crystal or equivalent) 222. The frequency of the phase locked loop circuit 250 is set by the controller 252, and controls the operating frequency channel and frequency band. The controller 252 may, for example, select the operating frequency channel and/or frequency band of the system. Also included in the RF communication module 212 are support blocks 254, which may include voltage and current references, trimming components, bias generators and/or other circuit components for supporting the operation of the transceiver circuitry.

In operation, an RF signal received by the antenna 216 is amplified by the LNA 224, which feeds the down conversion mixer 226, 228 to translate the desired RF band to a complex signal. The output of the down conversion mixer 226, 228 is then buffered 230, 232, filtered by the image reject filter 234 and slicer 236, 238 and input to the baseband processor 240. The baseband processor 240 performs baseband processing functions, such as synchronizing the incoming data stream, extracting the main payload and any auxiliary data channels (RSSI and AFC information), and performing necessary error detection and correction on the data blocks. In addition, the baseband processor 240 decompresses/decodes the received data blocks to extract the audio signal.

Outgoing audio and/or control signals may be encoded and formatted for RF transmission by the baseband processor 240. In the case of outgoing audio signals, the baseband processor 240 may also perform audio compression functions. The processed signal is modulated to an RF carrier by the modulator 241 and up conversion mixer 242, 244. The RF signal is then amplified by the power amplifier 246 and transmitted over the air medium by the antenna 216.

The hearing instrument processor 214 may perform traditional hearing instrument processing functions to compensate for the hearing impairments of a hearing instrument user, along with the binaural processing functions described herein. The hearing instrument processor 214 may also perform other signal processing functions, such as directional processing, occlusion cancellation, or other functions.

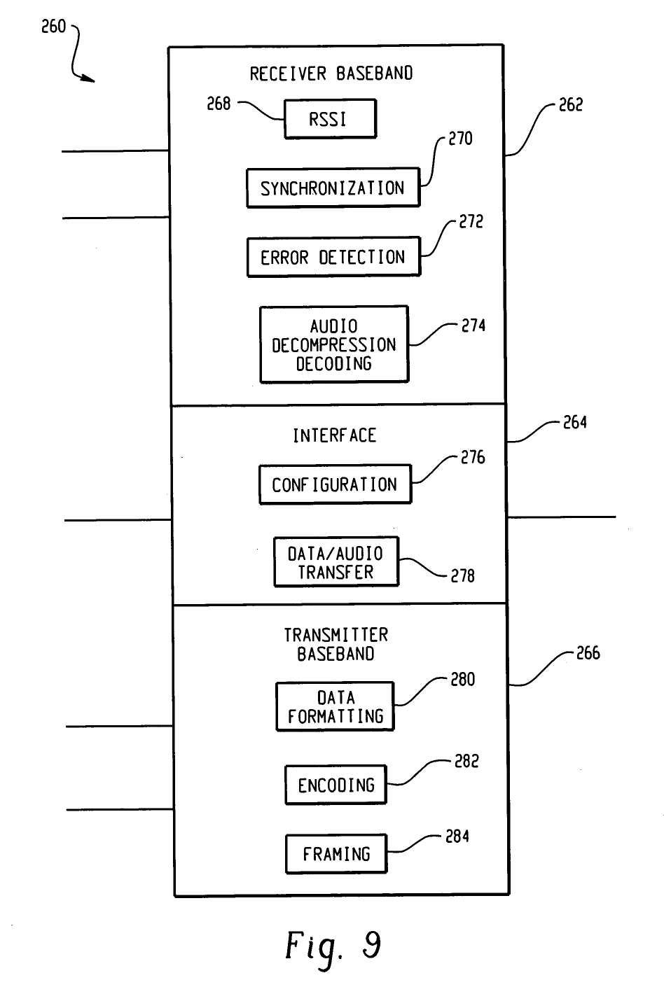

FIG. 9 is a functional diagram of an example baseband processor 260 for a hearing instrument. The baseband processor 260 may perform receiver baseband processing functions 262, interface functions 264 and transmitter baseband processing functions 266. The illustrated baseband processor 260 includes two receiver inputs, two interface input/outputs, and two transmitter outputs, corresponding to the input/outputs to the baseband processor 240 shown in FIG. 8. It should be understood, however, that other input/output configurations could be used.

The receiver baseband processing functions 262 include signal level baseband functions 268, 270, such as a synchronization function 270 to synchronize with the incoming data stream, and a data extraction function 268 for extracting the payload data. Also included in the receiver functions 262 are an error detection function 272 for detecting and correcting errors in the received data blocks, and an audio decompression decoding function 274 for extracting an audio signal from the received data blocks.

The transmitter baseband processing functions 266 include data formatting 280 and framing 284 functions for converting outgoing data into an RF communication protocol and an encoding function 282 for error correction and data protection. The RF communication protocol may be selected to support the transmission of high quality audio data as well as general control data, and may support a variable data rate with automatic recognition by the receiver. The encoding function 282 may be configurable to adjust the amount of protection based on the content of the data. For example, portions of the data payload that are more critical to the audio band from 100 Hz to 8 kHz may be protected more than data representing audio from 8 kHz to 16 kHz. In this manner, high quality audio, although in a narrower band, may still be recovered in a noisy environment. In addition, the transmitter baseband processing functions 266 may include an audio compression function for compressing outgoing audio data for bandwidth efficient transmission.

The interface functions 264 include a configuration function 276 and a data/audio transfer function 278. The data/audio transfer function 278 may be used to transfer data between the baseband processor 260 and other circuit components (e.g., a hearing instrument processor) or external devices (e.g., computer, CD player, etc.) The configuration function 276 may be used to control the operation of the communications circuitry. For example, the configuration function 276 may communication with a controller 252 in the communications circuitry to select the operating frequency channel and/or frequency band.

This written description uses examples to disclose the invention, including the best mode, and also to enable a person skilled in the art to make and use the invention. The patentable scope of the invention may include other examples that occur to those skilled in the art. For example, in other embodiments the link between the two hearing instruments in the binaural hearing instrument systems described herein may be a wired connection, instead of a wireless link. In another example, one of the hearing instrument in a binaural hearing instrument system may be used as a remote microphone that transmits audio to the other hearing instrument. For instance, one hearing instrument may be placed in the vicinity of the signal of interest, while the other hearing instrument is worn by the user. The audio received by the hearing instrument being used as a remote receiver may then be transmitted over a wireless link between the hearing instruments and output to the user from the worn hearing instrument.

It is claimed:

1. A binaural hearing instrument system, comprising:
a left hearing instrument configured to receive a left audio input signal and generate a left audio output signal, wherein the left audio output signal may be directed into a left ear of a hearing instrument user;
a right hearing instrument configured to receive a right audio input signal and generate a right audio output signal, wherein the right audio output signal may be directed into a right ear of the hearing instrument user;
the left and right hearing instruments including communications circuitry, the communications circuitry being configured to transmit data wirelessly between the left and right hearing instruments;
the left hearing instrument including a left binaural processing circuit that is configured to generate the left audio output signal as a function of the left audio input signal, a signal-to-noise ratio (SNR) of the left audio input signal, and a SNR of the right audio input signal;
the right hearing instrument including a right binaural processing circuit that is configured to generate the right audio output signal as a function of the right audio input signal and the SNRs of the left and right audio input signals;
wherein the data transmitted between the left and right hearing instruments by the communications circuitry is used to provide the SNR of the left audio input signal to the right hearing instrument and to provide the SNR of the right audio input signal to the left hearing instrument.

2. The system of claim 1, wherein the SNRs of the left and right audio input signals are included in the data that is transmitted between the left and right hearing instruments by the communications circuitry.

3. The system of claim 1, wherein the data transmitted between the left and right hearing instruments by the communications circuitry includes audio signals.

4. The system of claim 3, wherein the audio signals transmitted between the left and right hearing instruments by the communications circuitry are used to determine the SNRs of the left and right audio input signals.

5. The system of claim 4, wherein:
the left hearing instrument receives the right audio input signal via the communications circuitry and uses the right audio input signal to determine the SNR of the right audio input signal; and
the right hearing instrument receives the left audio input signal via the communications circuitry and uses the left audio input signal to determine the SNR of the left audio input signal.

6. The system of claim 5, wherein:
the left binaural processing circuit is configured to generate the left audio output signal as a function of the left and right audio input signals and the SNRs of the left and right audio signals; and
the right binaural processing circuit is configured to generate the right audio output signal as a function of the left and right audio input signals and the SNRs of the left and right audio signals.

7. The system of claim 6, wherein:
the left binaural processing circuit combines the left audio input signal and the right audio input signal to generate the left audio output signal based on the SNRs of the left and right audio input signal; and
the right binaural processing circuit combines the left audio input signal and the right audio input signal to generate the right audio output signal based on the SNRs of the left and right audio input signal.

8. The system of claim 1, wherein the SNRs of the left and right audio signals are calculated at multiple frequency bands, and wherein the data transmitted between the left and right hearing instruments provides the SNRs of the left and right audio signals at each of the frequency bands.

9. A method of processing audio signals in a binaural hearing instrument system that includes a left hearing instrument and a right hearing instrument, the binaural hearing instrument system being configured to transmit information wirelessly between the left and right hearing instruments, the method comprising:
receiving a left audio input signal;
determining a signal-to-noise ratio of the left audio input signal;
receiving a right audio input signal;
determining a. signal-to-noise ratio of the right audio input signal;
generating a left audio output signal based on the signal-to-noise ratios of both the left and right audio input signals; and
generating a right audio output signal based on the signal-to-noise ratios of both the left and right audio input signals.

10. The method of claim 9, further comprising:
transmitting data from the left hearing instrument to the right hearing instrument that identifies the signal-to-noise ratio of the left audio input signal; and
transmitting data from the right hearing instrument to the left hearing instrument that identifies the signal-to-noise ratio of the right audio input signal.

11. The method of claim 9, further comprising:
transmitting the left audio signal from the left hearing instrument to the right hearing instrument; and
transmitting the right audio signal from the right hearing instrument to the left hearing instrument;
wherein the left audio output signal is generated by combining the right and left audio input signals as a function of the signal-to-noise ratios;
wherein the right audio output signal is generated by combining the right and left audio input signal as a function of the signal-to-noise ratios.

12. The method of claim 11, wherein each of the left and right hearing instruments determine the signal-to-noise ratio of both the left and right audio inputs.

13. A binaural hearing instrument system, comprising:
means for receiving a left audio input signal; and
means for determining a signal-to-noise ratio of the left audio input signal;
means for receiving a right audio input signal;
means for determining a signal-to-noise ratio of the right audio input signal;
means for generating a left audio output signal based on the signal-to-noise ratios of both the left and right audio input signals; and
means for generating a right audio output signal based on the signal-to-noise ratios of both the left and right audio input signals.
